(19) United States
(12) Patent Application Publication
(10) Pub. No.: US 2025/0199833 A1
(43) Pub. Date: Jun. 19, 2025

(54) SYSTEM TO CONVERT ABSTRACT STORAGE SOLUTION INPUT DATA INTO A CLUSTER TOPOLOGY FOR DEPLOYMENT AND UPDATES OF A CLUSTERED FILE SYSTEM

(71) Applicant: Dell Products L.P., Round Rock, TX (US)

(72) Inventors: Michael Baptist, Boise, ID (US); Steven Soumpholphakdy, Chicago, IL (US); Benjamin E. Neigebauer, Rosemount, MN (US)

(21) Appl. No.: 18/538,135

(22) Filed: Dec. 13, 2023

(51) Int. Cl. G06F 9/455

(52) U.S. Cl. CPC G06F 9/45558; G06F 2009/45575; G06F 2009/45595

(57) ABSTRACT

The technology described herein is directed towards deploying a node cluster, e.g., in a cloud environment, based on abstract user storage solution inputs/service level objective input data, including user-specified storage capacity and performance characteristics. An intelligent system converts the input data into cluster topology data (e.g., virtual machines, storage devices/volumes and other information) that can be used for initial cluster deployment or infrastructure updates to existing node clusters in multi-cloud environments. The input data can be directed to an initial deployment of a new node cluster or an update to an existing node cluster. Further, the system can take customer rules as input data, monitor cluster conditions corresponding to those rules, and update the cluster based on a condition in the rules being met, by taking an action associated with the rule's condition to automatically generate and handle a cluster update request.

### BACKGROUND

In cloud environments, users (e.g., customers) need to configure various details for their node clusters to be deployed. This includes customers having to manually create the resources to deploy, including virtual machines (nodes), and bootstrap each virtual machine. Bootstrapping of the virtual machines requires understanding what has been (or is to be) deployed and in what environment. This typically takes experience, time and resources, can lead to frustrating errors, and so on, and thus results in a poor customer experience in general. Similar post-deployment issues result when a user wants to update an existing cluster infrastructure, e.g., grow or shrink the cluster, merge resources, scale up performance, and the like.

### BRIEF DESCRIPTION OF THE DRAWINGS

The technology described herein is illustrated by way of example and not limited in the accompanying figures in which like reference numerals indicate similar elements and in which:

FIG. 1 is a block diagram showing an example system/architecture in which a planner converts user service level objectives (SLO data) into parameters formatted for triggering deployment of a node cluster, in accordance with various aspects and implementations of the subject disclosure.

FIGS. 2 and 3 comprise a block diagram of planner components, logic and dataflow related to triggering deployment of a node cluster, in accordance with various aspects and implementations of the subject disclosure.

FIG. 4 is a flow diagram showing example operations related to handling an SLO-based request to deploy a node cluster, in accordance with various aspects and implementations of the subject disclosure.

FIG. 5 is a flow diagram showing example operations related to handling a request to update a node cluster, in accordance with various aspects and implementations of the subject disclosure.

FIG. 6 is a flow diagram showing example operations related to automatically updating a node cluster based on a monitored condition of the node cluster being met, in accordance with various aspects and implementations of the subject disclosure.

FIG. 7 is a flow diagram showing example operations related to determining a first number of virtual machine instances and a second number of storage devices to deploy in a node cluster based on storage capacity data representative of a specified storage capacity for the node cluster and performance metric data, in accordance with various aspects and implementations of the subject disclosure.

FIG. 8 is a flow diagram showing example operations related to determining node cluster topology for deploying a node cluster, in accordance with various aspects and implementations of the subject disclosure.

FIG. 9 is a flow diagram showing example operations related to updating a node cluster, in accordance with various aspects and implementations of the subject disclosure.

FIG. 10 is a block diagram representing an example computing environment into which aspects of the subject matter described herein may be incorporated.

FIG. 11 depicts an example schematic block diagram of a computing environment with which the disclosed subject matter can interact/be implemented at least in part, in accordance with various aspects and implementations of the subject disclosure.

### DETAILED DESCRIPTION

Various aspects of the technology described herein are generally directed towards an intelligent system that allows a user to provide straightforward service level objectives data (SLO details/data) and based on these SLO data, convert this information into a cluster topology that can be deployed. Once deployed, the system also can be used to determine changes (deltas) in topology for a cluster infrastructure update and the deltas to be applied (e.g., to grow or shrink the cluster).

In general, when initially deploying a node cluster, the system translates the user-inputted SLO data, including specified capacity data and performance metric data, into a viable cluster configuration specification representing the node cluster topology. In one implementation, the system includes planner engine/workflow comprising a cluster configuration generator component that returns the cluster configuration/topology to a cloud infrastructure request generator component of the planner. In turn, the cloud infrastructure request generator translates the output topology from the cluster configuration generator into an infrastructure data structure (e.g., an infrastructure file), and adds cloud-specific business logic to the data structure. The data structure is of a format understood and useable by an existing orchestration (deployment) engine to deploy cluster resources and interface with the cloud provider to form a node cluster in the cloud environment.

Once deployed, any updates to the node cluster infrastructure can be handled by similarly updating the infrastructure data structure (e.g., file). Such updates can be user-specified, and/or based on a set of defined rules corresponding to user-defined cluster conditions as detected by a monitoring system. In general, the monitoring system can accept rules to make its decision on are conditions that can be monitored (e.g., via telemetry data) or measured (e.g., time). For example, if a user prespecifies a defined rule indicating that X amount of capacity is to be added to a particular cluster whenever the current storage capacity exceeds a certain capacity limit condition, the system increases the storage capacity automatically upon detection of this condition being satisfied. To this end, the system consumes telemetry data from the node cluster and can thus monitor for the capacity condition being met. When met, the system makes a storage request to the planner to determine the additional resources to be created. The output of this request appends the additional resource details to the node cluster's existing plan, for example, for the deployment engine to carry out the update work.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimize,” “optimization,” “optimal,” “optimally” and the like only represent objectives to move towards a more optimal state, rather than necessarily obtaining ideal results. For example, “optimal” placement of a subnet means selecting a more optimal subnet over another option, rather than necessarily achieving an optimal result. Similarly, “maximize” means moving towards a maximal state (e.g., up to some processing capacity limit), not necessarily achieving such a state.

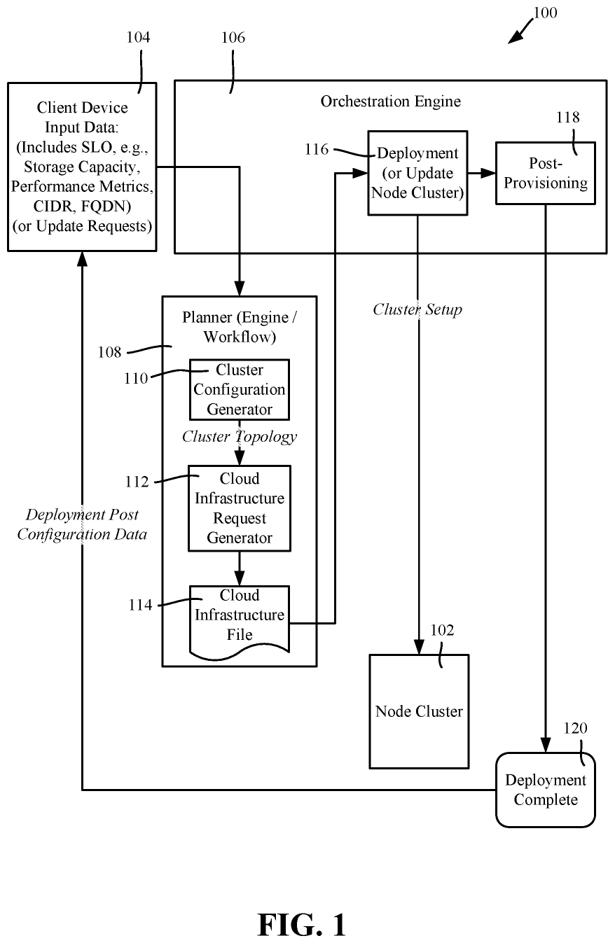

FIG. 1 shows a generalized block diagram of an example system/architecture 100 including components that can be used to deploy a node cluster 102, and once deployed can be used to maintain/modify the node cluster 102. A client device 104, e.g., operated by a user or client process, inputs a request for storage capacity, which in this example represents a request to deploy a new node cluster. The request includes input data including how much storage capacity is needed, along with defined performance metric data. The request also includes a delegated subnet, e.g., that specifies a classless interdomain routing (CIDR) block of internet protocol (IP) address space and a fully qualified domain name (FQDN) by which the user can connect to the cluster and connect to cluster services.

The input data, e.g., forwarded via an orchestration (deployment and update) engine 106, is received by a planner (e.g., engine/workflow) 108, which determines the number of nodes (i.e., virtual machines, synonymous with nodes as used herein) and storage devices needed to operate the cluster with the specified storage capacity with the specified client performance metrics. The virtual machines and storage volumes can be of specific types based on the cloud provider so as to match the specified input data. In general and as described herein, in one example implementation a cluster configuration (config) generator 110 incorporated into (or otherwise coupled to) the planner 108 converts the storage request into cluster topology information. Then, a cloud infrastructure request generator 112 (incorporated into or otherwise coupled to the planner 108) converts the cluster topology into a cloud infrastructure file 114 (or other suitable data structure) that is understood and will be used by the orchestration engine 106 (e.g., a multi-cloud capable provisioner) to deploy/execute workflows (block 116), along with controlling post-provisioning (block 118). These workflows can initially deploy the node cluster 102, and later update the node cluster 102 as requested.

Various bootstrap data including appropriate metadata is provided to the virtual machine(s) so that they can bootstrap and form a cluster. In the example implementation, the infrastructure request generator 112 fills in this metadata (i.e., the-cloud specific business logic) that the multi-cloud deployer knows how to use and include as part of starting the VM(s). Later, in the case of cluster infrastructure updates, new virtual machines being created or updated also are given the appropriate metadata to bootstrap and take the appropriate action with regards to an existing cluster (e.g., to grow, merge, for throughput scale up, re-merge, shrink or the like). When deployment is complete (block 120), the client device 104 obtains various post-configuration deployment data for connecting to the node cluster and associated cluster services.

With this technology, a customer is able to deploy a cluster by only needing to specify generally well-understood SLO details such as, but not limited to, for example, total raw capacity, performance tier data, aggregate throughput, IOPS, and so forth. The customer does not have to understand or worry about what type(s) of virtual machines need to be deployed, how many of those virtual machines are appropriate, the types of storage volumes/devices to attach to the virtual machines, and/or what size and volume count per virtual machine, for example.

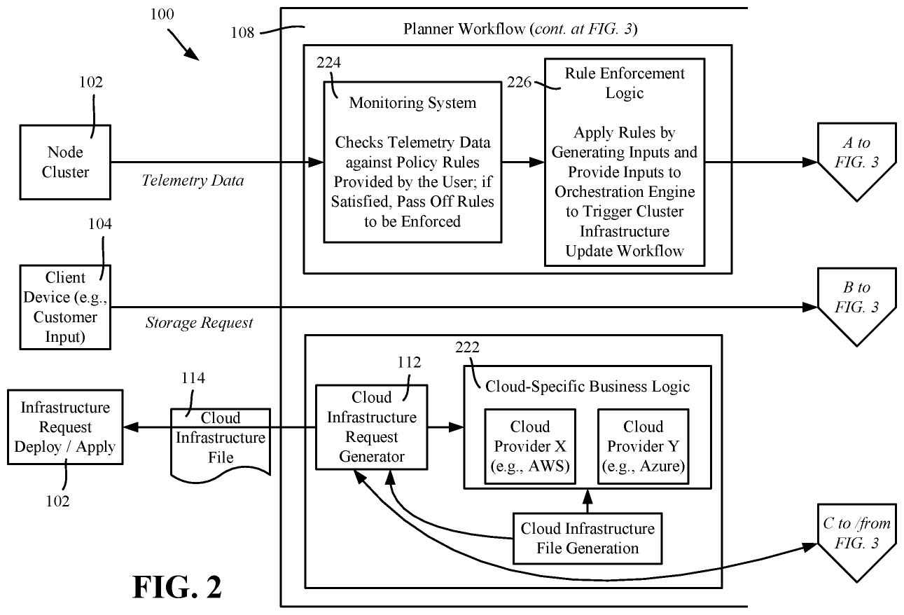

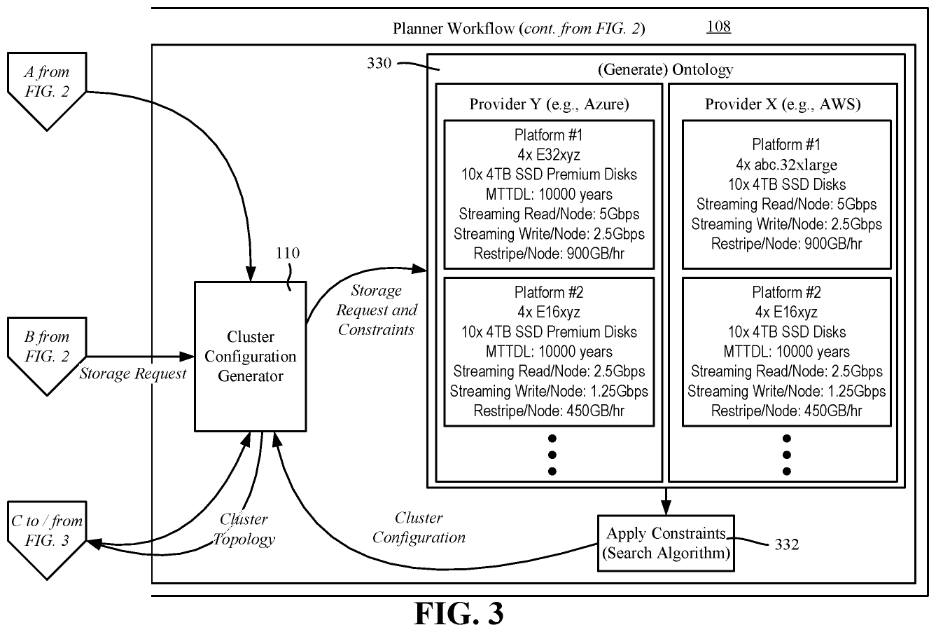

Additional details are represented in FIGS. 2 and 3, in which (as in FIG. 1) the system 100 starts with a storage request from a client device 104, which can comprise a request for SLO data from the end-user. The storage request is passed into (e.g., forwarded by the orchestration engine to) the planner 108. In the example implementation described herein, the planner 108 is comprised of two components, namely the cluster configuration generator 110 (FIG. 3) and the cloud infrastructure request generator 112 (FIG. 3). To reiterate, the configuration generator 110 converts the storage request into cluster topology data and the cloud infrastructure request generator 112 converts the cluster topology into a cloud infrastructure file 114 that is used with a request to deploy the node cluster 102 (FIG. 1). The same system 100 and the components of FIGS. 2 and 3 can be used to update a previously deployed, existing cluster.

The cluster configuration generator 110 performs the translation of the SLO data (and any constraint input data) into a viable cluster configuration specification (cluster topology information). To this end, in one example implementation the cluster configuration generator 110 can incorporate or be coupled to an ontology 330 and a search engine/algorithm 332. The ontology 330 allows creating target cloud provider-unique virtual machines, volume types, costing structures, performance metrics, and so on, as well as specifying attributes and properties for each of those entities. The ontology can 330 support interpolated attributes that allow the estimation of values based on other configurations that are generally similar. The interpolated attributes can be used for items such as mean time to data loss (MTTDL), time-to-reprotect data upon failure (sometimes referred to as “restripe”) performance, and the like. The search engine/algorithm 332 provides a way to filter and process the possible cluster configurations and return a set of configurations matching the input constraints. Combining the ontology 330 and the search engine/algorithm 332 allows the cluster configuration generator 110 to return a cluster topology to be passed to the cloud infrastructure request generator 112.

The cloud infrastructure request generator 112 translates the output from the cluster configuration generator 110 into a file format (known to the orchestration engine) to produce the cloud infrastructure file 114. The cloud infrastructure request generator 112 also inserts additional cloud-specific business logic 222 into the cloud infrastructure file 114. Example cloud-specific business logic that can be inserted includes (but is not limited to) bootstrapping information (passed in as user-data/custom-data, e.g., when a first virtual machine is started) for how to provision resources and/or split up the delegated subnet (CIDR block) for node cluster load balancing and failover operations.

As part of the operations of the cloud infrastructure request generator 112, the cloud infrastructure request generator 112 can also add a user-data object that includes key: value pairs such as including, but not limited to, storage deviceID:disk size, storage deviceID:disk journal type, and other information, e.g., as-a-service solution information, and so on. The cloud infrastructure request generator 112 also divides up the user-provided CIDR block into groups of IP address ranges and maps the ranges to intended usages (functions/modes), e.g., cloud network reserved IP addresses, service IP addresses, a primary/static IP address range and secondary dynamic IP address range for virtual network interface cards; the groups are used for setting up post-configuration operations to complete deployment. In this way, the output generated by the planner (workflow) 108 provides the details that are needed to be able to deploy and connect to a node cluster solution in the cloud. Later, customer input data can also be used to update an existing node cluster.

Beyond leveraging customer input data, the system 100 depicted in FIGS. 2 and 3 can be used to execute cluster infrastructure update workflows based on a set of defined rules corresponding to user-provided policy data. The policy data can be part of the initial user input data, or can be input (or modified if existing) at a later time.

The planner 108 (or another component of the intelligent system 100 coupled thereto) can include a monitoring system 224 that consumes telemetry data from the deployed and operating node cluster to monitor whether condition data, corresponding to the policy data's rules, is met. If the condition data is met, rule enforcement logic 226 is then invoked to take an action (or actions) associated with the rule; e.g., the rule enforcement logic 226 of the planner 108 applies rules by generating appropriate input data to determine the resources to be modified based on a rule to enforce/the action(s) to take, and providing the generated input data to the cluster configuration generator 110 for processing and sending to the cloud infrastructure request generator 112 for formatting the change data, e.g., appending the change data to the infrastructure file. When the infrastructure file is ready, the planner 108 triggers the orchestration engine 106 to perform the corresponding cluster infrastructure update workflow.

By way example, consider that a user determines that X amount of storage capacity is to be automatically added to the user's cluster whenever the amount of storage capacity in use exceeds a certain capacity limit, e.g., seventy percent of total. The intelligent system 100 is set to monitor for this condition, and does so by consuming telemetry data from the node cluster at the monitoring system (block 224). In this way the monitoring system 224 monitors for the “seventy percent of total capacity in use” condition being met. When the condition is satisfied, the rule enforcement logic 226 takes the appropriate action by making a storage request to the planner 108 to add the rule-specified X amount of storage capacity, whereby the planner 108 determines the additional resources to be created, which triggers the orchestration engine to run its “grow cluster” workflow. In one implementation, the new request updates the existing infrastructure file for this node cluster, e.g., appends the additional resource details to the existing plan (configuration file) for the orchestration engine/deployment engine 106 to carry out the work needed to add the storage capacity.

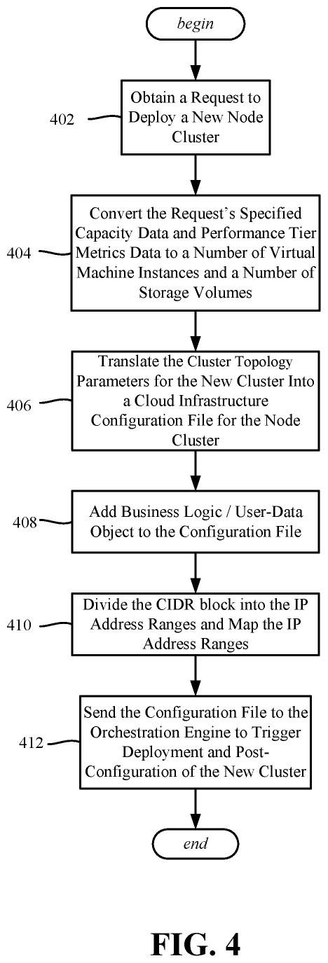

FIG. 4 is a flow diagram showing example operations of the planner 108 in handling a request related to deploying a new node cluster, beginning at operation 402 which represents obtaining the request, e.g., forwarded by the orchestration engine from a client device. At operation 404, the planner 108 (e.g., the planner's cluster configuration generator 110 in the example implementation) processes the request, which includes converting the request's specified capacity data and performance tier metrics data to a number of virtual machine instances and the number of storage volumes per virtual machine that accommodate the request. Operation 404 results in generating ontology data for these parameters for the new cluster, e.g., by accessing similar (or exactly matching) ontology information via the search algorithm as described herein with reference to FIGS. 2 and 3.

Operation 406 represents the planner (e.g., the planner's cloud infrastructure request generator 112 in the example implementation) translating the output from the cluster configuration generator (the cluster topology parameters for the new cluster) into the cloud infrastructure configuration file for this node cluster. Operation 408 represents adding the business logic/user-data object (e.g., including the relevant key: value pairs) to the configuration file. Operation 410 represents dividing up the CIDR block into the IP address ranges and mapping these ranges to their respective usage functions/modes.

At this time, the configuration file includes the details and post-configuration information (e.g., the FQDN and the IP address ranges) that are needed to form the new cluster and execute the post-configuration operations once the cluster is formed. Operation 412 represents sending this information via the configuration file to the orchestration engine, which triggers deployment operations, including formation and post-configuration of the new cluster.

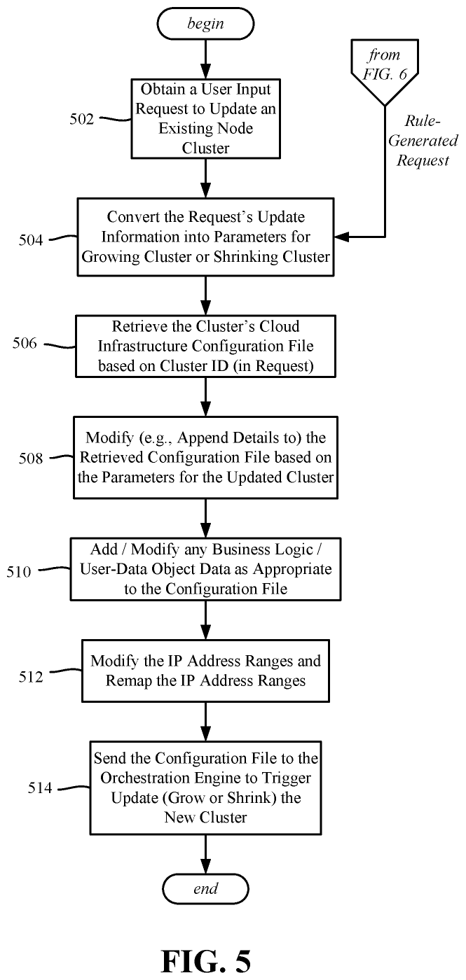

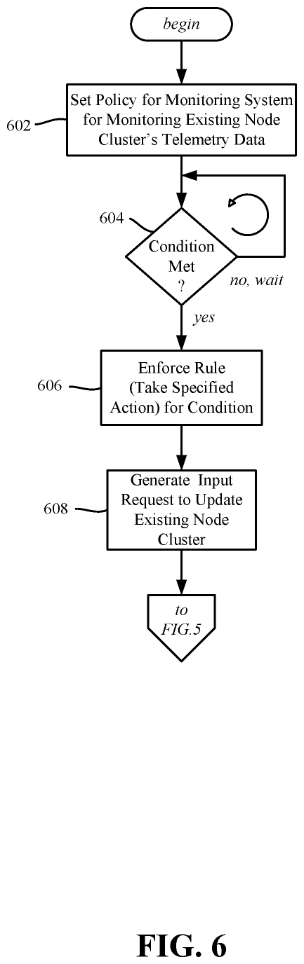

FIG. 5 is a flow diagram showing example operations of the planner 108 in handling a request related to updating an existing node cluster, beginning at operation 502 which represents obtaining the request from user input data, e.g., forwarded by the orchestration engine. At operation 504, the planner (e.g., the planner's cluster configuration generator 110 in the example implementation) processes the request, which includes converting the request's update information into parameters for growing or shrinking the cluster, depending on what is specified in the request. Note that operation 504 can be triggered from FIG. 6 as described below with reference to enforcing a rule.

Operation 506 represents the planner (e.g., the planner's cloud infrastructure request generator 112 in the example implementation) retrieving the existing cluster's configuration file, which can be maintained in any suitable reliable storage location or obtained on demand by communicating with a cluster service. The request includes the cluster's identifier (a system-unique ID, e.g., created as part of deployment) which distinguishes the cluster from other clusters of the system, and is used to access the cluster's configuration file.

Operation 508 represents the planner modifying the parameters of the configuration file for the updated cluster, which can be accomplished by appending change data to the configuration file. Operation 510 represents adding any change-related business logic/user-data object (e.g., including the relevant key: value pairs) to the configuration file; for example, if growing the cluster by adding new virtual machines and associated storage volumes, the business logic/user-data object needs to be added for the new virtual machines.

Operation 512 represents remapping the CIDR block IP address ranges as appropriate for the update. For example, if the update is a grow cluster update that adds nodes to the cluster, pools of IP addresses associated with the nodes need to be increased with additional IP addresses to allocate the new IP addresses to the new nodes. Conversely, for shrinking a cluster by removing nodes, IP addresses allocated to those nodes to be removed can be reclaimed for later use should the cluster subsequently grow.

At this time, the configuration file includes the modification information needed to update the cluster. Operation 514 represents sending this information via the updated configuration file to the orchestration engine 106 (FIG. 1), which triggers deployment and post-configuration of the new cluster.

FIG. 6 is a flow diagram showing example operations of the planner 108 with respect to updating an existing cluster based on a condition specified in a rule having been met. Operation 602 represents setting the policy for the monitoring system to monitoring the node cluster's telemetry data; as described herein, the rule (or multiple) rules can be specified prior to cluster deployment, or specified/modified any time thereafter.

Operation 604 represents waiting for a condition to be met; as is understood this can be event driven or polled, depending on a given implementation. Note that multiple conditions can be met at the same time, which can be handled one at a time, or substantially in parallel if non-conflicting, e.g., by applying multiple rules to cause multiple actions to be performed in a single update if possible.

Operation 606 represents enforcing the rule, which takes the action associated with the condition that is specified as part of the rule. Operation 608 generates the input request to update the existing node cluster, which is then handled by the planner 108, e.g., starting at operation 504 of FIG. 5 as previously described.

Turning to use case examples, consider an initial deployment scenario in which a customer inputs a storage request specified for deployment with the following storage capacity data, performance data, and additional information, including the delegated subnet/CIDR block and a fully qualified domain name (FQDN) associated with connectivity and service IP addresses and the like. In this example, the input information provides constraints/SLOs via the below input data (excluding the CIDR block and FQDN which are not constraints/SLOs); the input data includes:
320 TB raw capacity
Streaming Read: 4 Gbps/Node Writes: 2 Gbps/Node
192.168.100.0/24 CIDR for Connectivity
FQDN for DNS (domain name system).

As described herein, the cluster configuration generator converts the 320 TB and performance tier data to virtual machines and volumes, e.g.:
8×E32xyz VM instances (where “E32xyz” represents any appropriate type of virtual machine/VM)
10×4 TB SSD volumes for each VM.

As also described herein, the cluster configuration generator converts the output from the cluster configuration generator into the cloud infrastructure configuration file, adds user-data object such as including key: value pairs for disk size, journal type, as-a-service solution information and so on. The cluster configuration generator also divides up the specified CIDR block into the IP ranges and maps the ranges as described herein. The result is that the cloud infrastructure configuration file has the details required to deploy and execute post-configuration operations for the cluster, with the file sent to the orchestration engine to orchestrate deployment, and return information by which the customer can begin using the cluster.

Another use-case example corresponds to a cluster infrastructure change, such as based on the following storage request for infrastructure change being sent to planner workflow by customer input (with the constraint being the capacity to add with the performance tier to meet the new SLO):
Add 320 TB raw capacity
Performance Tier
Existing Cluster ID
Existing Cluster Details: 4×E32xyz VM instances with 10×4 TB SSD volumes

As described herein, the cluster configuration generator converts the 320 TB and performance tier data to virtual machines and volumes, e.g.:
8×E32xyz VM instances w/10×4 TB SSD volumes for each VM.
   This is based on the existing cluster details and wanting to keep a homogenous cluster.

As also described herein with reference to FIG. 5, the cluster configuration generator finds the previous cloud infrastructure file based on the existing cluster ID in the request, appends details for updates to be made to the existing cluster, and generates user-data object that includes key: value pairs for the new nodes resulting from the addition of capacity. The result is that the updated cloud infrastructure configuration file has the details required to update the cluster, with the file sent to the orchestration engine to update the existing cluster by kicking off the “grow cluster” workflow.

Another use-case example corresponds to a similar cluster infrastructure change, such as based on the following storage request for an infrastructure change being sent to planner workflow by the rule enforcement logic based on detection by the monitoring system of a condition being satisfied; (the constraint is in the form of the threshold to monitor (70 percent full) and the capacity (SLO) to add if that specified 70 percent capacity full threshold is met):
Set Policy to Monitoring System
   Add 320 TB raw capacity of Performance Tier if existing cluster is 70% full for ClusterID
Telemetry Data sent to monitoring indicating cluster is now 70% full
Storage Request made to Planner Workflow.

As described herein, the cluster configuration generator converts the 320 TB and performance tier data to virtual machines and volumes, e.g.:
8×E32xyz VM instances w/10×4 TB SSD volumes for each VM.
   This is based on the existing cluster details and wanting to keep a homogenous cluster.

The cluster configuration generator can communicate with a multi-cloud service that provides the current state of the infrastructure. As also described herein with reference to FIG. 5, the cluster configuration generator appends details for updates to be made to the existing cluster, and generates user-data object that includes key: value pairs for the new nodes. The result is that the updated cloud infrastructure configuration file has the details required to update the cluster, with the file sent to the orchestration engine to update the existing cluster by kicking off the grow cluster workflow.

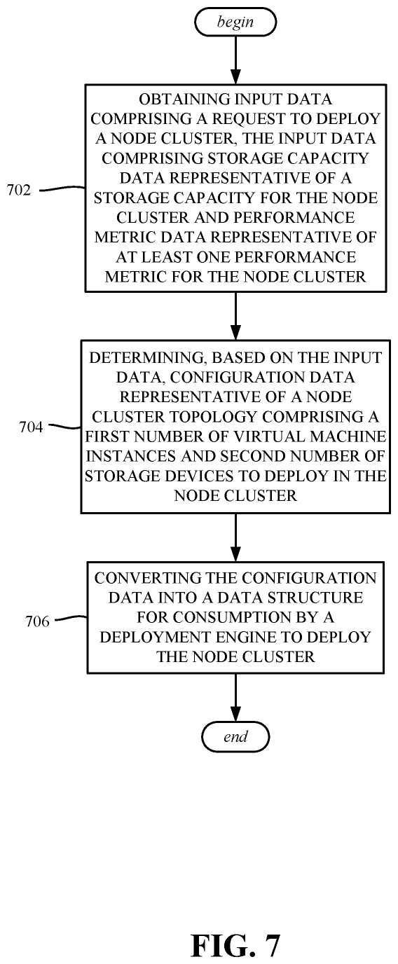

One or more aspects can be embodied in a system, such as represented in the example operations of FIG. 7, and for example can include a memory that stores computer executable components and/or operations, and a processor that executes computer executable components and/or operations stored in the memory. Example operations can include operation 702, which represents obtaining input data comprising a request to deploy a node cluster, the input data comprising storage capacity data representative of a storage capacity for the node cluster and performance metric data representative of at least one performance metric for the node cluster. Example operation 704 represents determining, based on the input data, configuration data representative of a node cluster topology comprising a first number of virtual machine instances and second number of storage devices to deploy in the node cluster. Example operation 706 represents converting the configuration data into a data structure for consumption by a deployment engine to deploy the node cluster.

The node cluster can operate in a cloud computing environment, and further operations can include adding cloud-specific business data to the data structure prior to the consumption by the deployment engine.

Further operations can include generating a user-data object comprising storage device-related data, and adding the user-data object to the data structure prior to the consumption by the deployment engine.

The node cluster can operate in a cloud computing environment, and further operations can include obtaining a classless interdomain routing (CIDR) block of internet protocol (IP) address space, dividing the CIDR block into non-overlapping groups of IP addresses based on expected usage by resources of the node cluster, and outputting data representative of the groups of IP addresses to the deployment engine.

The node cluster can operate in a cloud computing environment, and determining the configuration data can include accessing an ontology to create at least one of: virtual machines targeted for the cloud computing environment, target cloud provider volume types targeted for the cloud computing environment, costing structure data targeted for the cloud computing environment, or performance metrics targeted for the cloud computing environment.

Determining the configuration data can include accessing an ontology to specify at least one of: attributes or properties for the at least one of the virtual machines targeted for the cloud computing environment, the target cloud provider volume types targeted for the cloud computing environment, the costing structure data targeted for the cloud computing environment, or the performance metrics targeted for the cloud computing environment.

Determining the configuration data can include searching the ontology based on the input data to obtain closely matching node cluster configuration datasets, and combining the closely-matching node cluster configurations datasets into the configuration data representative of the node cluster topology. The determination of what is closely-matching can be determined according to a specified or defined matching criterion. The ontology can support interpolated attributes to facilitate searching with estimated value data based on similar configuration datasets.

Further operations can include, after deployment of the node cluster, obtaining an update request comprising change data directed to the node cluster, obtaining the data structure, determining, based on the change data, updated configuration data comprising an updated first number of virtual machine instances and an updated second number of storage devices to operate in the node cluster, and converting the data structure, based on the updated configuration data, into an updated data structure for further consumption by the deployment engine to update the node cluster. The storage capacity data can be first storage capacity data that represents currently existing storage capacity of the node cluster, and the change data can correspond to: a request to increase storage capacity to a second storage capacity relative to the currently existing storage capacity, or a request to decrease storage capacity to a second storage capacity relative to the currently existing storage capacity.

Further operations can include obtaining policy data representative of a constraint condition applicable to the node cluster and an action to take in response to determining the constraint condition has been satisfied, setting a monitoring system coupled to the node cluster to evaluate whether the constraint condition is satisfied, obtaining an update request corresponding to an indication from the monitoring system that the constraint condition is satisfied, and in response to the update request, causing the action to be taken, comprising obtaining the data structure, determining, based on the update request, updated configuration data, and converting the data structure, based on the updated configuration data, into an updated data structure for further consumption by the deployment engine to update the node cluster.

The updated configuration data can include at least one of: an updated first number of virtual machine instances to deploy in the node cluster, or an updated second number of storage devices to deploy in the node cluster.

The action to be taken can be to increase storage capacity from the storage capacity to an increased storage capacity.

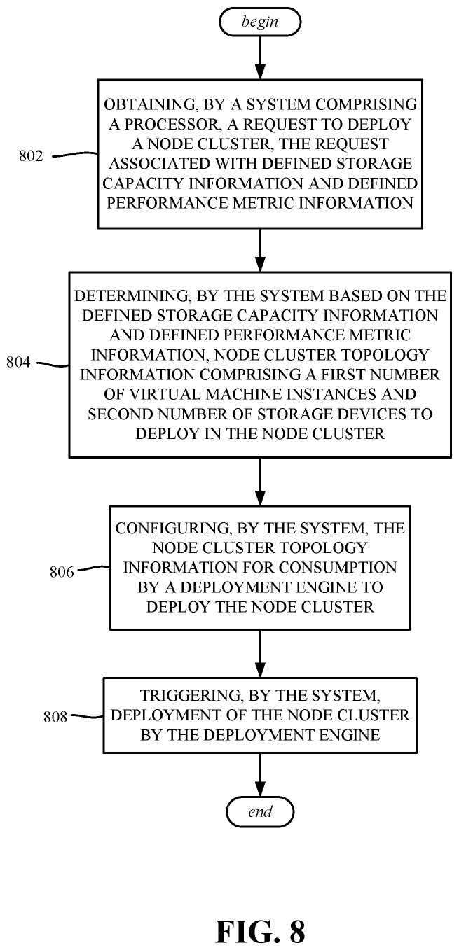

One or more example aspects, such as corresponding to example operations of a method, are represented in FIG. 8. Example operation 802 represents obtaining, by a system comprising a processor, a request to deploy a node cluster, the request associated with defined storage capacity information and defined performance metric information. Example operation 804 represents determining, by the system based on the defined storage capacity information and defined performance metric information, node cluster topology information comprising a first number of virtual machine instances and second number of storage devices to deploy in the node cluster. Example operation 806 represents configuring, by the system, the node cluster topology information for consumption by a deployment engine to deploy the node cluster. Example operation 808 represents triggering, by the system, deployment of the node cluster by the deployment engine.

Further operations can include, in response to an infrastructure change request, updating, by the system, the node cluster topology information into updated node cluster topology information, reconfiguring, by the system, the node cluster topology information into updated the node cluster topology information for consumption by the deployment engine, and triggering, by the system, updating of the node cluster by the deployment engine.

Further operations can include obtaining, by the system, the infrastructure change request based on user input information.

Further operations can include obtaining, by the system, the infrastructure change request based on monitored telemetry information representative of a defined node cluster condition being satisfied, wherein the determining of the node cluster topology information corresponds to a defined action to take upon the defined node cluster condition being satisfied.

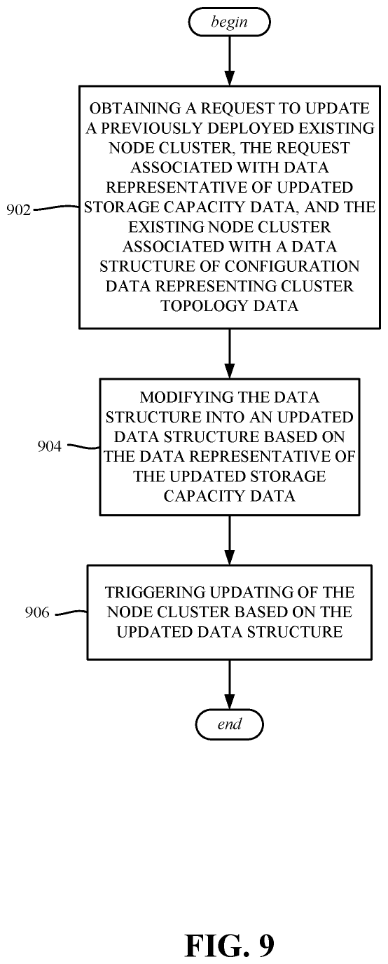

FIG. 9 summarizes various example operations, e.g., corresponding to a machine-readable medium, comprising executable instructions that, when executed by a processor, facilitate performance of operations. Example operation 902 represents obtaining a request to update a previously deployed existing node cluster, the request associated with data representative of updated storage capacity data, and the existing node cluster associated with a data structure of configuration data representing cluster topology data. Example operation 904 represents modifying the data structure into an updated data structure based on the data representative of the updated storage capacity data. Example operation 906 represents triggering updating of the node cluster based on the updated data structure.

Obtaining the request can be based on received user input data representative of user input.

The existing node cluster can be monitored for defined node cluster condition data being satisfied, the defined node cluster condition data can be associated with an action to take upon detection of the defined node cluster condition data being satisfied, the obtaining of the request can be based on detection of the defined node cluster condition data being satisfied, and the modifying of the data structure into the updated data structure and the triggering of the updating of the node cluster can correspond to the action to take.

As can be seen, the technology described herein is directed to an intelligent system that facilitates deployment of a node cluster, in which the system removes complex manual steps from a user's experience, is adaptable for future cloud features/enhancements, and reduces the time and effort it takes to provide the end-user with a new node cluster or update a node cluster based on a storage request. To the end, the system converts certain performance characteristics and capacity into a cluster topology that can be used by a cloud deployment engine.

For an already existing node cluster, the system can be used to update infrastructure (e.g., grow, shrink, scale up/down the cluster or the like). The request to the system comes in the form of an update, resulting in updated infrastructure details being generated then applied to the existing cluster. The system can take customer rules as an input to monitor cluster conditions based on telemetry data from the cluster so as to a trigger an automatically a trigger cluster infrastructure update upon a condition being met. The system can run checks on the telemetry data to determine if a storage request for an update needs to be made, and at any point where a condition is met, the system can produce the input data for the orchestration engine to carry out the cluster infrastructure update.

Furthermore, the system can be configured to assist in deploying solutions that are cost effective based on additional metrics (e.g., $/GB, $/1K IOPS, $/1 Gbps, and the like). The solution can also facilitate making decisions based on desired outcomes (e.g., cloud provider, as-a-service versus customer managed) that can be used in deploying the infrastructure for the customer.

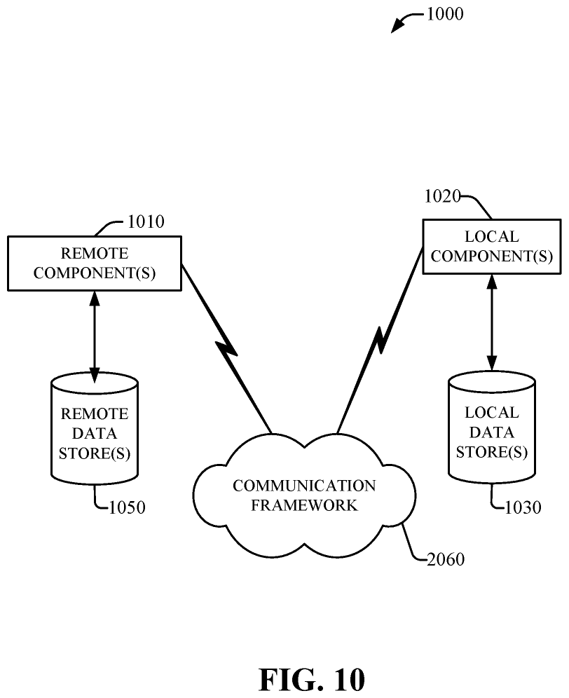

FIG. 10 is a schematic block diagram of a computing environment 1000 with which the disclosed subject matter can interact. The system 1000 comprises one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

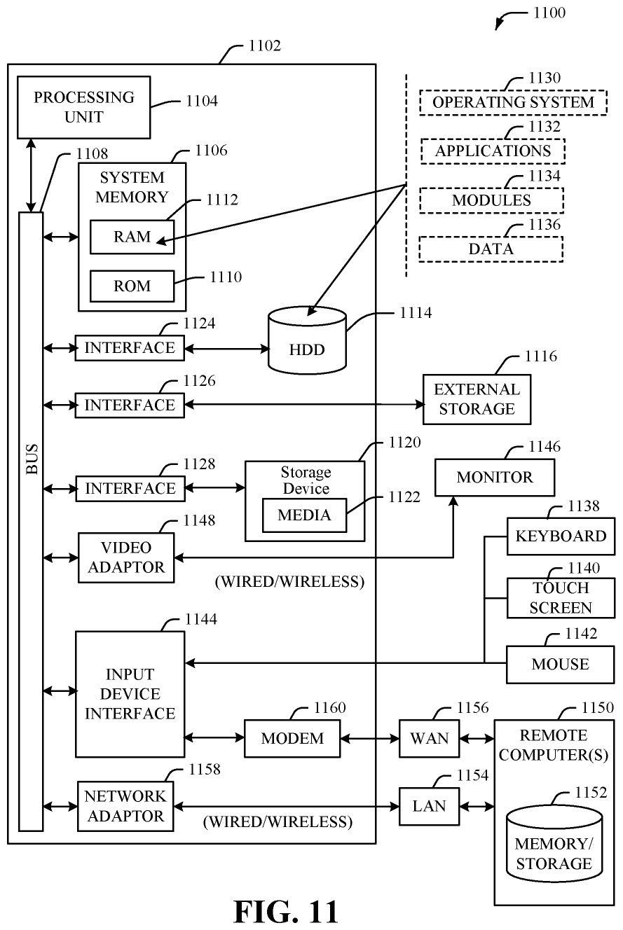

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (virtual machine) of multiple virtual machines hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
obtaining input data comprising a request to deploy a node cluster, the input data comprising storage capacity data representative of a storage capacity for the node cluster and performance metric data representative of at least one performance metric for the node cluster;
determining, based on the input data, configuration data representative of a node cluster topology comprising a first number of virtual machine instances and second number of storage devices to deploy in the node cluster; and
converting the configuration data into a data structure for consumption by a deployment engine to deploy the node cluster.

2. The system of claim 1, wherein the node cluster operates in a cloud computing environment, and wherein the operations further comprise adding cloud-specific business data to the data structure prior to the consumption by the deployment engine.

3. The system of claim 1, wherein the operations further comprise generating a user-data object comprising storage device-related data, and adding the user-data object to the data structure prior to the consumption by the deployment engine.

4. The system of claim 1, wherein the node cluster operates in a cloud computing environment, and wherein the operations further comprise obtaining a classless interdomain routing (CIDR) block of internet protocol (IP) address space, dividing the CIDR block into non-overlapping groups of IP addresses based on expected usage by resources of the node cluster, and outputting data representative of the groups of IP addresses to the deployment engine.

5. The system of claim 1, wherein the node cluster operates in a cloud computing environment, and wherein the determining of the configuration data comprises accessing an ontology to create at least one of: virtual machines targeted for the cloud computing environment, target cloud provider volume types targeted for the cloud computing environment, costing structure data targeted for the cloud computing environment, or performance metrics targeted for the cloud computing environment.

6. The system of claim 5, wherein the determining of the configuration data comprises accessing an ontology to specify at least one of: attributes or properties for the at least one of the virtual machines targeted for the cloud computing environment, the target cloud provider volume types targeted for the cloud computing environment, the costing structure data targeted for the cloud computing environment, or the performance metrics targeted for the cloud computing environment.

7. The system of claim 6, wherein the determining of the configuration data comprises searching the ontology based on the input data to obtain closely matching node cluster configuration datasets, and combining the closely-matching node cluster configurations datasets into the configuration data representative of the node cluster topology.

8. The system of claim 7, wherein the ontology supports interpolated attributes to facilitate searching with estimated value data based on similar configuration datasets.

9. The system of claim 1, wherein the operations further comprise, after deployment of the node cluster, obtaining an update request comprising change data directed to the node cluster, obtaining the data structure, determining, based on the change data, updated configuration data comprising an updated first number of virtual machine instances and an updated second number of storage devices to operate in the node cluster, and converting the data structure, based on the updated configuration data, into an updated data structure for further consumption by the deployment engine to update the node cluster.

10. The system of claim 9, wherein the storage capacity data is first storage capacity data that represents currently existing storage capacity of the node cluster, and wherein the change data corresponds to: a request to increase storage capacity to a second storage capacity relative to the currently existing storage capacity, or a request to decrease storage capacity to a second storage capacity relative to the currently existing storage capacity.

11. The system of claim 1, wherein the operations further comprise obtaining policy data representative of a constraint condition applicable to the node cluster and an action to take in response to determining the constraint condition has been satisfied, setting a monitoring system coupled to the node cluster to evaluate whether the constraint condition is satisfied, obtaining an update request corresponding to an indication from the monitoring system that the constraint condition is satisfied, and in response to the update request, causing the action to be taken, comprising obtaining the data structure, determining, based on the update request, updated configuration data, and converting the data structure, based on the updated configuration data, into an updated data structure for further consumption by the deployment engine to update the node cluster.

12. The system of claim 11, wherein the updated configuration data comprises at least one of: an updated first number of virtual machine instances to deploy in the node cluster, or an updated second number of storage devices to deploy in the node cluster.

13. The system of claim 12, wherein the action to be taken is to increase storage capacity from the storage capacity to an increased storage capacity.

14. A method, comprising:
obtaining, by a system comprising a processor, a request to deploy a node cluster, the request associated with defined storage capacity information and defined performance metric information;
determining, by the system based on the defined storage capacity information and defined performance metric information, node cluster topology information comprising a first number of virtual machine instances and second number of storage devices to deploy in the node cluster;
configuring, by the system, the node cluster topology information for consumption by a deployment engine to deploy the node cluster; and
triggering, by the system, deployment of the node cluster by the deployment engine.

15. The method of claim 14, further comprising, in response to an infrastructure change request, updating, by the system, the node cluster topology information into updated node cluster topology information, reconfiguring, by the system, the node cluster topology information into updated the node cluster topology information for consumption by the deployment engine, and triggering, by the system, updating of the node cluster by the deployment engine.

16. The method of claim 14, further comprising obtaining, by the system, the infrastructure change request based on user input information.

17. The method of claim 14, further comprising obtaining, by the system, the infrastructure change request based on monitored telemetry information representative of a defined node cluster condition being satisfied, wherein the determining of the node cluster topology information corresponds to a defined action to take upon the defined node cluster condition being satisfied.

18. A non-transitory machine-readable medium, comprising executable instructions that, when executed by a processor, facilitate performance of operations, the operations comprising:
obtaining a request to update a previously deployed existing node cluster, the request associated with data representative of updated storage capacity data, and the existing node cluster associated with a data structure of configuration data representing cluster topology data;
modifying the data structure into an updated data structure based on the data representative of the updated storage capacity data; and
triggering updating of the node cluster based on the updated data structure.

19. The non-transitory machine-readable medium of claim 18, wherein the obtaining of the request is based on received user input data representative of user input.

20. The non-transitory machine-readable medium of claim 18,
wherein the existing node cluster is monitored for defined node cluster condition data being satisfied,
wherein the defined node cluster condition data is associated with an action to take upon detection of the defined node cluster condition data being satisfied,
wherein the obtaining of the request is based on detection of the defined node cluster condition data being satisfied, and
wherein the modifying of the data structure into the updated data structure and the triggering of the updating of the node cluster corresponds to the action to take.
